(19) United States
(12) Patent Application Publication
(10) Pub. No.: US 2018/0271110 A1
(43) Pub. Date: Sep. 27, 2018

(54) REDUCTION OF MICROBIAL ACTIVITY AND METHOD OF PROCESSING ANIMAL AND POULTRY PRODUCTS

(71) Applicant: Zee Company, Chattanooga, TN (US)

(72) Inventors: Robert C. Bullard, Signal Mountain, TN (US); Jonathon R. Bullard, Chattanooga, TN (US); James A. Faller, Chattanooga, TN (US)

(73) Assignee: Zee Company, Chattanooga, TN (US)

(21) Appl. No.: 15/935,633

(22) Filed: Mar. 26, 2018

Related U.S. Application Data
(60) Provisional application No. 62/483,057, filed on Apr. 7, 2017.
(60) Provisional application No. 62/476,274, filed on Mar. 24, 2017.

(51) Int. Cl. A23B 4/20; A23B 4/06

(52) U.S. Cl. CPC A23B 4/20; A23V 2002/00; A23B 4/06

(57) ABSTRACT

A process for reducing the bacterial count on a four-legged animal, poultry animal, carcass of such animals, or meat or processed meat products of such animals, during processing, such reduction using a solution comprising a N,N′-dichloro-5,5-dialkylhydantoin, a N,N′-dichloro-5-ethyl-5-methylimidazolidine-2,4-dione, or combinations thereof, and in some preferable aspects 1,3,-dichloro-5,5,-dimethylhydantoin, 1,3-dichloro-5-ethyl-5-methylimidazolidine-2,4-dione, or combinations thereof.

The present application claims the benefit of U.S. Provisional Application No. 62/476,274, filed Mar. 24, 2017, and U.S. Provisional Application No. 62/483,057, filed Apr. 7, 2017, which is hereby incorporated herein in its entirety by reference.

### TECHNICAL FIELD

The present invention relates to a method of reducing the bacterial count on animal products, including four-legged meat products and poultry, during processing by exposing the animal, animal carcass and/or raw meat product and/or processed meat products derived from the carcasses of such animals to a solution comprising at least one N,N′-dichloro-5,5-dialkylhydantoin, at least one N,N′-dichloro-5-ethyl-5-methylimidazolidine-2,4-dione or combinations and mixtures thereof, such as 1,3,-dichloro-5,5,-dimethylhydantoin and/or 1,3-dichloro-5-ethyl-5-methylimidazolidine-2,4-dione, more particularly soaking, dipping, quenching, rinsing, spraying and/or washing with a solution comprising 1,3,-dichloro-5,5,-dimethylhydantoin and/or 1,3-dichloro-5-ethyl-5-methylimidazolidine-2,4-dione.

### BACKGROUND

The world population has grown to point where mass production of the foods that we consume is no longer a luxury but a requirement. Local farmers, providing food and food products directly to the marketplace, cannot meet the demands of modern society. The food supply chain now incorporates very large, complex farms and high speed and very high volume processing plants to satisfy the need for mass processing and production of food. Maintaining a safe food supply chain relies on the dedication of those working in the supply chain, the processing plants and also on the third party oversight of various Federal agencies whose regulations support and mandate food safety.

With two major exceptions, the physical process of taking an animal from the farm to the consumer has changed very little over time. The introduction of refrigeration, and the implementation of various chemistries to help maintain sanitary conditions and to control microbiology, has given modern food processors an advantage not enjoyed by food producers of a century ago. Refrigeration and chemical intervention practices have become an integral part of food processing facility operations. These technologies have enabled the high speed, high volume output of the large processing facilities that could not have been possible in times past without significant concern for consumer safety. With large scale and continuous processing methods being employed by large processors of protein products, or any other product that is susceptible to microbiological contamination, the concern for the control of microbiology and the safety of the food supply chain is of paramount importance.

Another concern, as the demand for food products increases, is the impact on natural resources created by this demand. The ecological impact is directly affected by this growth and therefore new processes must be developed to reduce the impact any given process has on the environment. The ecological impact that a food processing plant has on the environment is no longer a passing concern but a major part of operations and planning. Entire processes are built around the control and conservation of natural resources such as water. Older, outdated and less efficient processes are being replaced at significant cost with more efficient and less wasteful processes that maximizes the utility of available resources. No longer can a plant operate without concern for the conservation and sustainability of natural resources. As each step in food processing becomes more efficient, the natural resources required to be used in subsequent steps can be minimized to conserve and sustain our natural resources.

Still another concern in slaughtering and processing plants is unwanted microorganisms that are emitted into the air or are contained on the animal carcass when the animal is processed, such as red meat (i.e., beef, pork, etc.) and poultry (i.e., turkey, duck and chicken) during shackling, killing, scalding, and picking areas. The microorganisms that may become airborne or contained on the animal carcass are unwanted in the processing and packing areas of the plant because they can affect product quality and safety. They also pose a potential threat to the health and well-being of the workers in the plant. Still further, such microorganisms can affect down-field processes in a processing plant, posing quality and safety concerns to the ultimate consumer of the poultry product.

To insure that the food supply chain in modern society is maintained at the highest levels of safety for the consumer, the plant's employees, and the overall environment, there are federal agencies that monitor the processors operations so that a continually safe food supply is assured and the environmental impact and utilization of natural resources is as safe and efficient as possible. Modern food processing methods are scrutinized by government agencies to ensure compliance with safe handling and processing guidelines designed to minimize issues of food safety in the supply chain Regulations and routine inspections of systems and processes by Federal agencies such as the USDA, EPA and OSHA, mandate a government-industry alliance that helps ensure that every effort is made to deliver the safest food product possible to the consumer.

Very innovative approaches to the systems and methods used in processing facilities have been implemented to create profits for industry while maintaining low consumer cost of the final product. As new processes are developed, the federal agencies that have jurisdiction over any particular process are called upon to review the new approach and to ensure that the new innovation meets the current guidelines for safety. The higher the processors output, the higher the risk of microbiological contamination, and therefore the more innovative the processor must be to combat this ever present threat to the food chain safety. As new risks are found, federal guidelines become more stringent.

Large scale refrigeration systems, used to help control microbial growth in various processing applications, have helped the food processing industry to remain in compliance with food safety goals. Refrigeration applications and processes are implemented at various locations in the processing operation to ensure maximization of microbiology control and shelf life. Depending on the particular product being processed—beef, pork, poultry and fish for example—and the particular operation taking place, various methods of achieving this reduction in product temperature are employed. In industrial processing of poultry, for example, immediately after slaughter, bleed out, hot water immersion, feather removal and viscera withdrawal, poultry carcasses have to be chilled to reduce their temperature from approximately 40° C. to 4° C., which contributes to food safety. While poultry carcasses may undergo air chilling after evisceration, in countries such as the United State and Brazil, two of the biggest poultry producers in the world, poultry carcasses usually undergo immersion chilling after evisceration by submersing the poultry carcass in large chilled water bath tanks.

Immersion chilling has a benefit of an increased “washing effect” which lowers the total microbial load on the birds; however, it is also a potential place for cross contamination to occur. In order to control microbiology in chiller tanks, it is a typical practice to add specialized chemistry to the tanks throughout the processing day. This specialized chemistry, known in the industry as intervention solutions kill or provide a log₁₀ reduction in the amount of any unwanted microorganisms. There are several antimicrobials that are approved and effective for use in the chiller or other process steps to decrease pathogens, including, for instance, chlorine, peroxyacetic acid (“PAA”), CPC, organic acids, TSP, acidified sodium chlorite and chlorine dioxide. Because chiller tanks are often quite voluminous, the amount of antimicrobials needed can be quite high to provide a desired log₁₀ reduction in the amount of any unwanted microorganisms.

PAA, which is also sometimes called peroxyacetic acid, is a peroxycarboxylic acid and is a well known chemical for its strong oxidizing potential, has the molecular formula CH₃COOOH, and has a molecular structure as follows:

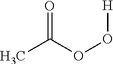

An equilibrium peroxyacetic acid solution is produced from an equilibrium mixture of hydrogen peroxide, acetic acid and water (“equilibrium PAA solution”), which often uses an acid catalyst, e.g., sulfuric acid.

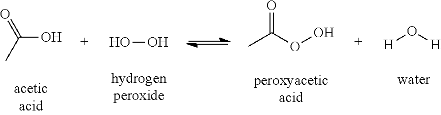

U.S. Pat. No. 5,632,676, which pertains to the application of equilibrium PAA solutions to fowl at an application concentration of about 100 ppm to about 2000 ppm, discloses such equilibrium solutions having a pH around 3.

Beyond equilibrium PAA solutions, other equilibrium peroxycarboxylic acid (“PCA”) solutions can also be produced from a similar equilibrium mixture of hydrogen peroxide, water and the respective acid. Such commercial products also often contain stabilizers and/or catalysts, like 1 Hydroxyethylidene 1-1 diphosphonic acid (HEDP), various phosphate salts, organic or inorganic acids, etc., to facilitate production and storage stability of the product. Hydrogen peroxide is always present in excess in the natural equilibrium formulation of PAA solutions (and other equilibrium PCA solutions).

Huge numbers of four-legged animals and poultry are slaughtered and processed for meat and meat products consumed either by humans or pets. Such animals include, for example, cattle, swine, horses, sheep, bison, rabbit, camel, kangaroo, alligator, crocodile, and other such existing or potential sources of meat products, such as buffalo, goats, and llamas. These and other four-legged meat-producing animals used for food and food products, e.g., deer, antelope, elk, squirrel, opossum, racoon, and nutria, are sometimes referred to collectively herein as four-legged slaughter animals. Also the term “cattle” is used in a generic sense to include steers, heifers, cows, calves, and bulls; “swine” is used in a generic sense to include hogs, sows, gilts, barrows, boars, and pigs; the term “sheep” is used in a generic sense to include lambs, rams and ewes; and the term “poultry” is used in a generic sense to include chickens, roosters, ducks, turkeys, pheasant, partridge and the like.

Many four-legged slaughter animals and poultry animals, especially those from which beef, pork, chicken and turkey are obtained, are processed by high-output meat packing plants using state-of-the-art technology. Despite modern processing procedures, bacterial contamination of fresh meat occurs as an undesirable but unavoidable result of converting live four-legged slaughter animals and poultry animals into food. Although current Good Manufacturing Procedures (GMPs) and/or recent government regulations can reduce this contamination, the total elimination of bacteria from fresh raw meats has not been achieved. Since deep muscle tissue is considered sterile in healthy animals, essentially all of the contamination originates from the carcass surfaces. Soil, dust and feces on the hair or feathers, hides and hooves of the animals represent one significant source of contamination. In addition, in some cases internal organs rupture during the removal process, resulting in further contamination of the carcass.

A number of the conventionally-used steps in the processing of four-legged slaughter animals and poultry animals for food constitute opportunities for microbial and pathogen contamination. A need thus exists for one or more new methods for reducing or eliminating such contamination of animal carcasses or parts thereof during the processing for food. Another need is for the provision of one or more methods which do not involve excessive expense in reducing or eliminating such contamination. A further need is for the provision of one or more methods which do not involve undue interference with existing slaughterhouse and/or meat packing operations.

Besides fulfilling the foregoing needs, it is vitally important that the method used to fulfill the foregoing needs not cause any noticeable degradation in the quality or properties of the meat from the carcasses, especially in the organoleptic appearance and taste of the meat.

As such, there is a need in the industry to efficiently and cost-effectively reduce microbial contamination of four-legged animal and poultry carcasses, parts and organs during processing of the animal, animal carcass and/or raw meat product and/or processed meat products.

### SUMMARY

In some aspects of the present invention, a method for decreasing microbial activity in protein food products intended for human consumption comprises contacting (I) a four-legged slaughter animal or poultry animal being processed for slaughter and/or (II) the carcass of such animal and/or (III) raw meat products and/or processed meat products derived from the carcasses of such animals with a solution comprising at least one N,N′-dichloro-5,5-dialkylhydantoin, at least one N,N′-dichloro-5-ethyl-5-methylimidazolidine-2,4-dione or combinations and mixtures thereof. In some aspects, the N,N′-dichloro-5,5-dialkylhydantoin comprises 1,3,-dichloro-5,5,-dimethylhydantoin. In some aspects, the N,N′-dichloro-5-ethyl-5-methylimidazolidine-2,4-dione comprises 1,3-dichloro-5-ethyl-5-methylimidazolidine-2,4-dione.

In some aspects of the present invention, in the processing of a four-legged slaughter animal, the exterior surfaces of a live four-legged slaughter animal are contacted prior to slaughter with an aqueous microbiocidal composition formed by mixing at least one N,N′-dichloro-5,5-dialkylhydantoin with an aqueous medium to form an aqueous microbiocidally-effective composition.

In some aspects of the present invention, in the processing of a four-legged slaughter animal, the exterior surfaces of a live four-legged slaughter animal are contacted prior to slaughter with an aqueous microbiocidal composition formed by mixing at least one N,N′-dichloro-5-ethyl-5-methylimidazolidine-2,4-dione with an aqueous medium to form an aqueous microbiocidally-effective composition.

In some aspects of the present invention, in the processing of a four-legged slaughter animal, the exterior surfaces of a live four-legged slaughter animal are contacted prior to slaughter with an aqueous microbiocidal composition formed by mixing at least one N,N′-dichloro-5,5-dialkylhydantoin, at least one N,N′-dichloro-5-ethyl-5-methylimidazolidine-2,4-dione, or a combination or a mixture thereof with an aqueous medium to form an aqueous microbiocidally-effective composition.

In some aspects of the present invention, in the processing of a poultry animal, the exterior surfaces of a live poultry animal are contacted prior to slaughter with an aqueous microbiocidal composition formed by mixing at least one N,N′-dichloro-5,5-dialkylhydantoin with an aqueous medium to form an aqueous microbiocidally-effective composition.

In some aspects of the present invention, in the processing of a poultry animal, the exterior surfaces of a live poultry animal are contacted prior to slaughter with an aqueous microbiocidal composition formed by mixing at least one N,N′-dichloro-5-ethyl-5-methylimidazolidine-2,4-dione with an aqueous medium to form an aqueous microbiocidally-effective composition.

In some aspects of the present invention, in the processing of a poultry animal, the exterior surfaces of a live poultry animal are contacted prior to slaughter with an aqueous microbiocidal composition formed by mixing at least one N,N′-dichloro-5,5-dialkylhydantoin, at least one N,N′-dichloro-5-ethyl-5-methylimidazolidine-2,4-dione, or a combination or a mixture thereof with an aqueous medium to form an aqueous microbiocidally-effective composition.

In some aspects of the present invention, at one or more suitable stages during the processing of the animal carcass, carcass surfaces of the slaughtered animal are contacted with an aqueous microbiocidal composition formed by mixing at least one N,N′-dichloro-5,5-dialkylhydantoin, at least one N,N′-dichloro-5-ethyl-5-methylimidazolidine-2,4-dione, or combinations thereof, with an aqueous medium to form an aqueous microbiocidally-effective composition. Depending upon the type of animal carcass being processed, such contacting can be conducted before, during and/or after removing the hide or feathers from the carcass, or before or after removing the hair and/or bristles or feathers from the carcass.

In some aspects of the present invention, at one or more suitable stages before, during and/or after the preparation of raw meat products and/or processed meat products, such products are contacted with an aqueous microbiocidal composition formed by mixing at least one N,N′-dichloro-5,5-dialkylhydantoin, at least one N,N′-dichloro-5-ethyl-5-methylimidazolidine-2,4-dione, or combinations thereof, with an aqueous medium to form an aqueous microbiocidally-effective composition. A few examples of raw meat products include steaks, chops, rib sections, meat roast cuts, hams, loins, breasts, legs, wings, quartered or halved carcasses, animal organs, trims, and ground meat. A few examples of processed meat products include ready-to-eat deli products, sausages, frankfurters, and sliced meats.

In some aspects of the present invention, after the chilling of raw meat products and/or processed meat products, such products are contacted with an aqueous microbiocidal composition formed by mixing at least one N,N′-dichloro-5,5-dialkylhydantoin, at least one N,N′-dichloro-5-ethyl-5-methylimidazolidine-2,4-dione, or combinations thereof, with an aqueous medium to form an aqueous microbiocidally-effective composition. In some aspects, the contact occurs after the raw meat products and/or processed meat products are chilled in a chilling tank having an intervention solution.

In some aspects of the present invention, the use of an aqueous microbiocidally-effective composition formed from one or more of N,N′-dichloro-5,5-dialkylhydantoin and N,N′-dichloro-5-ethyl-5-methylimidazolidine-2,4-dione, such as 1,3,-dichloro-5,5,-dimethylhydantoin and/or 1,3-dichloro-5-ethyl-5-methylimidazolidine-2,4-dione, provides substantial benefits over chlorine-containing biocidal agents such as hypochlorite. Further, such aqueous microbiocidally-effective compositions tend to be less corrosive to the nozzles, fittings, cabinets, transporting apparatus, and other parts of the various soaking, washing, dipping, quenching, showering, spraying, and/or misting systems used.

In some aspects of the present invention, the use of an aqueous microbiocidally-effective composition formed from one or more of N,N′-dichloro-5,5-dialkylhydantoin and N,N′-dichloro-5-ethyl-5-methylimidazolidine-2,4-dione, such as 1,3,-dichloro-5,5,-dimethylhydantoin and/or 1,3-dichloro-5-ethyl-5-methylimidazolidine-2,4-dione, provides substantial benefits over chlorine-containing biocidal agents such as hypochlorite. Further, such aqueous microbiocidally-effective compositions tend to be less corrosive to the nozzles, fittings, cabinets, transporting apparatus, and other parts of the various soaking, washing, dipping, quenching, showering, spraying, and/or misting systems used.

In some aspects of the present invention, N,N′-dichloro-5,5-dialkylhydantoin and N,N′-dichloro-5-ethyl-5-methylimidazolidine-2,4-dione, such as 1,3,-dichloro-5,5,-dimethylhydantoin and/or 1,3-dichloro-5-ethyl-5-methylimidazolidine-2,4-dione, provide greater effectiveness as antimicrobials as compared to many chlorine-containing biocides, such that an aqueous microbiocidally-effective composition comprising one or more of N,N′-dichloro-5,5-dialkylhydantoin and N,N′-dichloro-5-ethyl-5-methylimidazolidine-2,4-dione, such as 1,3,-dichloro-5,5,-dimethylhydantoin and/or 1,3-dichloro-5-ethyl-5-methylimidazolidine-2,4-dione, can be introduced into an aqueous medium at suitably low dosage levels and yet form compositions having enhanced microbiocidal effectiveness, and with no appreciable adverse effect when applied to a live four-legged slaughter animal or poultry animals being processed for slaughter. In addition, the N,N′-dichloro-5,5-dialkylhydantoins and/or N,N′-dichloro-5-ethyl-5-methylimidazolidine-2,4-diones form aqueous compositions that are stable over a range of temperatures from as low as just above the freezing point of the composition to about 70° C. and which throughout this temperature range are effective against microorganisms and pathogens even when such compositions are formed using low dosage levels of the N,N′-dichloro-5,5-dialkylhydantoin(s) and/or N,N′-dichloro-5-ethyl-5-methylimidazolidine-2,4-dione(s). Thus, the microbiocidally effective compositions of the present invention can be effectively utilized under most, if not all, temperature conditions encountered in the processing of four-legged slaughter animals and poultry animals, at least for meat.

It is noteworthy that poultry processing especially in modern highly automated plants, involves at least in the chill tank, long periods of time, e.g., an hour or so, during which the microbiocide can exert its microbiocidal activity. In contrast, in high-output meat packing plants and slaughterhouses in which cattle or pigs, or carcasses thereof are processed, hung for aging effects and/or cooling, sprays of relatively short duration are typically used. Therefore, the time available for a microbiocide to exert its microbiocidal activity is usually considerably shorter in such plants or slaughterhouses than in a plant processing poultry for edible meat products.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a flow diagram of poultry processing, with the reduction of the bacterial count on a poultry carcass according to certain aspects of the present invention occurring between the picking and chilling stages.

FIG. 2 is a flow diagram of processing red meat carcasses at slaughter, with the reduction of the bacterial count on a red meat carcass according to certain aspects of the present invention occurring after the evisceration and trimming stages.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

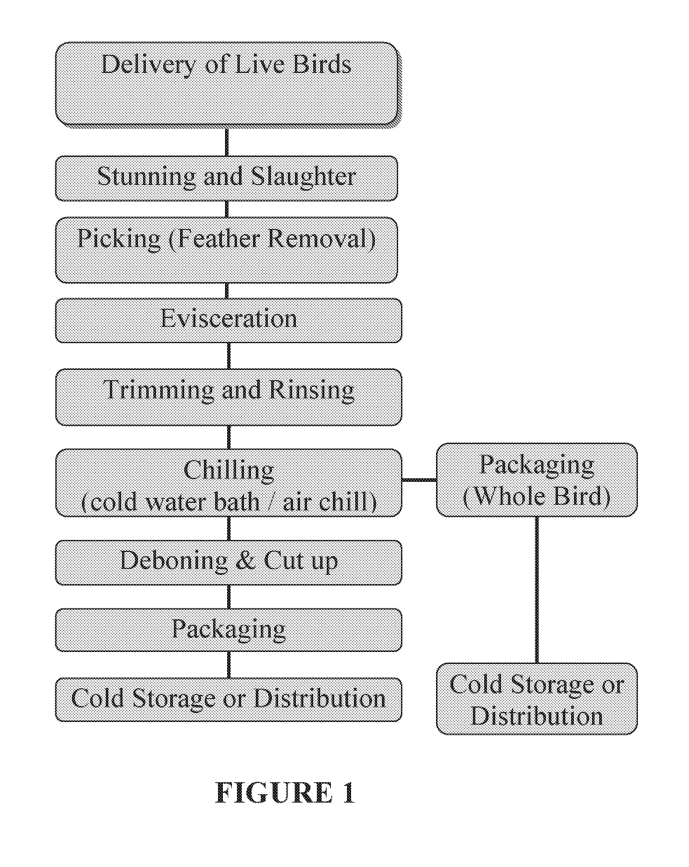

As illustrated in the flow diagram of FIG. 1, normally meat poultry processing is initiated by hanging, or shackling, the birds to a processing line after being transferred from coops or transport cages. After the stunning, bleeding and scalding stages, the bird typically undergoes a picking stage where the feathers are removed from the carcass using an automated picker machine. Prior to the chilling stage, the feet, head, neck, oil glands and internal organs can be removed from the carcass; and the can carcass be washed and cleaned for microbial (i.e., E. coli, Campylobacter, Salmonella) and visible concerns.

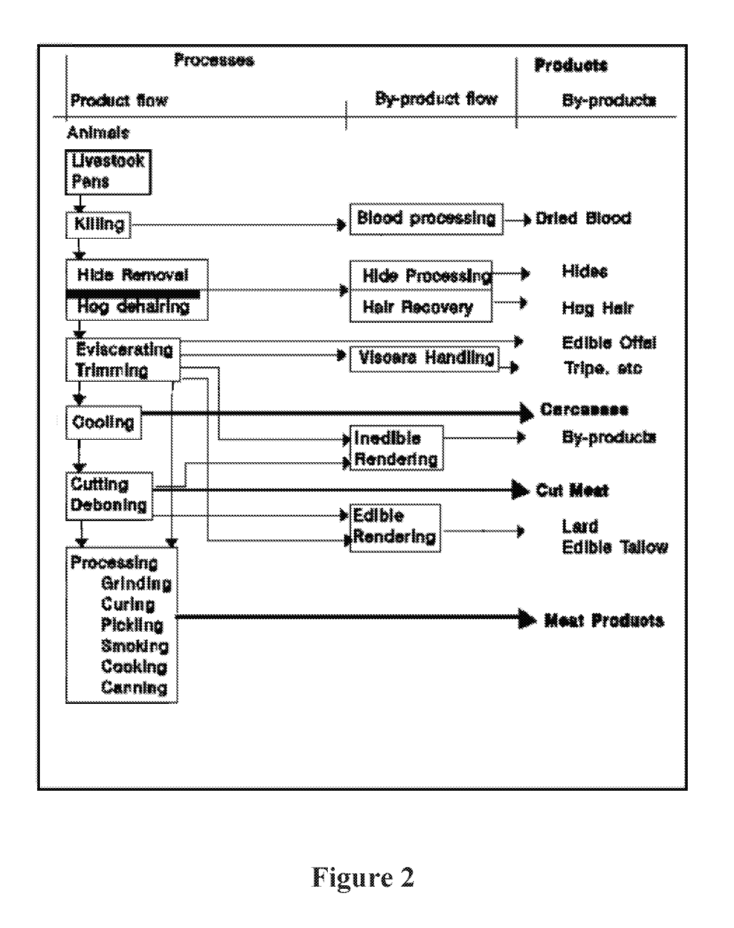

As illustrated in FIG. 2, the normal processing of four-legged animals is initiated by the livestock being killed followed with hide removal (i.e., cattle) or dehairing (i.e., pigs) followed by the eviscerating and trimming stages. After the eviscerating and trimming stages, the meat carcass, parts and/or organs typically undergo a cooling stage before cutting/deboning and ordinary processing for the resultant meat products. Prior to the chilling stage, the head, feet, and internal organs can be removed from the carcass; and the carcass can be washed and cleaned for microbial (i.e., E. coli, Listeria, Salmonella, etc.) and visible concerns.

In the present invention, the inventors have surprisingly discovered that in some aspects of the present invention, a method for decreasing microbial activity in protein food products intended for human consumption comprises contacting (I) a four-legged slaughter animal or poultry animal being processed for slaughter, and/or (II) the carcass of such animal, and/or (III) raw meat products and/or processed meat products derived from the carcasses of such animals with a solution comprising at least one N,N′-dichloro-5,5-dialkylhydantoin, at least one N,N′-dichloro-5-ethyl-5-methylimidazolidine-2,4-dione or combinations and mixtures thereof. In some aspects, the N,N′-dichloro-5,5-dialkylhydantoin comprises 1,3,-dichloro-5,5,-dimethylhydantoin. In some aspects, the N,N′-dichloro-5-ethyl-5-methylimidazolidine-2,4-dione comprises 1,3-dichloro-5-ethyl-5-methylimidazolidine-2,4-dione.

The aqueous microbiocidally-effective compositions of this invention are formed from components comprised at least of (i) water and (ii) at least one of N,N′-dichloro-5,5-dialkylhydantoin, N,N′-dichloro-5-ethyl-5-methylimidazolidine-2,4-dione, or combinations thereof. These components are mixed in microbiocidally-effective proportions, and such proportions can vary depending on various factors such as for example the animal species being processed, the time of the year the animals are being processed, the amount of microbial contamination on the animals being processed, the kind and extent of contamination to which the animals, carcasses, and/or parts thereof are exposed during the various operations conducted in a slaughter house or meat packing plant, and the type of object(s) being processed or prepared, whether live animal, animal carcass, raw meat product, and/or processed meat product. In general, however, the components water and at least one N,N′-dichloro-5,5-dialkylhydantoin and/or N,N′-dichloro-5-ethyl-5-methylimidazolidine-2,4-dione are proportioned such that an effective microbiocidal amount of microbiocide formed from water and the one or more N,N′-dichloro-5,5-dialkylhydantoin and/or N,N′-dichloro-5-ethyl-5-methylimidazolidine-2,4-dione is present in the resultant composition.

The amounts of one or more N,N′-dichloro-5,5-dialkylhydantoin and/or N,N′-dichloro-5-ethyl-5-methylimidazolidine-2,4-dione that are dissolved in water to form an aqueous microbiocidally-effective composition of the present invention may be expressed in terms of chlorine residual. Thus in the practice of the present invention, the water is mixed with at least one N,N′-dichloro-5,5-dialkylhydantoin and/or N,N′-dichloro-5-ethyl-5-methylimidazolidine-2,4-dione microbiocidal agent in an amount to achieve a chlorine residual of up to about 400 ppm (wt/wt) expressed as free chlorine, preferably up to about 200 ppm (wt/wt) expressed as free chlorine. More preferably, the amount of at least one N,N′-dichloro-5,5-dialkylhydantoin and/or N,N′-dichloro-5-ethyl-5-methylimidazolidine-2,4-dione microbiocidal agent mixed with water achieves a chlorine residual of up to about 100 ppm (wt/wt) expressed as free chlorine, and still more preferably up to about 50 ppm (wt/wt) expressed as free chlorine. Typically a minimum chlorine residual of at least about 0.5 ppm (wt/wt) expressed as free chlorine from one or more N,N′-dichloro-5,5-dialkylhydantoin and/or N,N′-dichloro-5-ethyl-5-methylimidazolidine-2,4-dione will be used especially in those compositions that are used for sanitizing or decontaminating raw meat products and/or processed meat products. Preferably a minimum chlorine residual of at least about 10 ppm (wt/wt) expressed as free chlorine, more preferably of at least about 20 ppm (wt/wt) expressed as free chlorine, and still more preferably of at least about 50 ppm (wt/wt) expressed as free chlorine from one or more N,N′-dichloro-5,5-dialkylhydantoin and/or N,N′-dichloro-5-ethyl-5-methylimidazolidine-2,4-dione will be used especially in those compositions that are used for sanitizing or decontaminating live four-legged slaughter animals, live poultry animals, and/or carcasses of such animals.

In some aspect of the present invention, particularly preferred especially for treating, sanitizing or decontaminating live four-legged slaughter animals, live poultry animals, and/or carcasses of such animals are aqueous microbiocidally-effective compositions of this invention having a chlorine residual in the range of about 20 to about 100 ppm (wt/wt) expressed as free chlorine from one or more N,N′-dichloro-5,5-dialkylhydantoin(s) and/or N,N′-dichloro-5-ethyl-5-methylimidazolidine-2,4-dione(s). Preferred compositions used for treating, sanitizing or decontaminating raw meat products and/or processed meat products are compositions having a chlorine residual in the range of about 0.5 to about 400 ppm (wt/wt) expressed as free chlorine from one or more N,N′-dichloro-5,5-dialkylhydantoin(s) and/or N,N′-dichloro-5-ethyl-5-methylimidazolidine-2,4-dione(s). More preferred compositions for use in treating, sanitizing or decontaminating raw meat products and/or processed meat products are compositions having a chlorine residual in the range of about 50 to about 200 ppm (wt/wt) expressed as free chlorine from one or more N,N′-dichloro-5,5-dialkylhydantoin(s) and/or N,N′-dichloro-5-ethyl-5-methylimidazolidine-2,4-dione(s). Still more preferred compositions for use in treating, sanitizing or decontaminating raw meat products and/or processed meat products are compositions having a chlorine residual in the range of about 50 to about 100 ppm (wt/wt) expressed as free chlorine from one or more N,N′-dichloro-5,5-dialkylhydantoin(s) and/or N,N′-dichloro-5-ethyl-5-methylimidazolidine-2,4-dione(s). The product solution is typically used at a temperature of about 1 to about 39° C., but can be used at higher temperatures, e.g., up to about 70° C., if desired. The term “expressed as free chlorine” denotes the way the concentrations are calculated and reported. It does not mean that free molecular chlorine is necessarily present. Instead, the solution contains chlorine in whatever chemical form(s) it exists when the N,N′-dichloro-5,5-dialkylhydantoins and/or N,N′-dichloro-5-ethyl-5-methylimidazolidine-2,4-dione s is dissolved in water.

Non-limiting examples of four-legged slaughter animals include cattle, swine, horses, sheep, bison, rabbit, camel, kangaroo, alligator, crocodile, and other such existing or potential sources of meat products, such as buffalo, goats, deer, antelope, elk, squirrel, rabbit, opossum, racoon, nutria and llamas. These and other four-legged meat-producing animals used for food and food products are sometimes referred to collectively herein as four-legged slaughter animals. Non-limiting examples of poultry animals include chickens, roosters, ducks, turkeys, pheasant, partridge and other such existing or potential sources of meat products, such as pigeons, quail and geese. These and other bird meat-producing animals used for food and food products are sometimes referred to collectively herein as poultry animals. Also: the term “cattle” is used in a generic sense to include steers, heifers, cows, calves, and bulls; “swine” is used in a generic sense to include hogs, sows, gilts, barrows, boars, and pigs; the term “sheep” is used in a generic sense to include lambs, rams and ewes; and the term “poultry” is used in a generic sense to include chickens, roosters, ducks, turkeys, pheasant, partridge and the like.

There are three general types of four-legged slaughter animal and/or poultry animal processing wherein this invention is applicable. They are:

I) administration of aqueous microbiocidally-effective compositions used pursuant to this invention to exterior surfaces of the live four-legged slaughter animals or poultry animals being processed for slaughter;

II) administration of aqueous microbiocidally-effective compositions used pursuant to this invention to the carcasses of freshly-slaughtered four-legged slaughter animals or poultry animals being processed for meat and/or meat products prior to evisceration; and

III) administration of aqueous microbiocidally-effective compositions used pursuant to this invention to the carcasses of freshly-slaughtered four-legged slaughter animals or poultry animals being processed for meat and/or meat products after evisceration, such as after a chilling stage within a chilling tank.

As noted above there is another category of processing wherein this invention is applicable, which is:

IV) administration of aqueous microbiocidally-effective compositions used pursuant to this invention to the raw meat products and/or processed meat products derived from the four-legged slaughter animals or poultry animals at any suitable stage(s) before, during, and/or after any operation used in the preparation and/or processing of such raw meat products and/or processed meat products.

### Type I Processing

As can be seen from the above, Type I processing pursuant to the present invention relates to reducing microbiocidal contamination of meat and/or meat products to be produced from the processing of the animals, by contacting exterior surfaces of the animal during one or more of the initial stages of the processing while the animal has not yet been killed. These stages include any pre-handling steps taken with the animals before they are killed (i.e., while they are still alive) such as receiving & holding the animal, moving the animal to the stunning area, stunning the animal, and handling or moving the stunned animal before exsanguination or evisceration. Thus, pursuant to certain aspects of the present invention, exterior surfaces of the animal are contacted with one or more aqueous microbiocidally-effective compositions of this invention during at least one such stage or step while the animal is still alive. In certain aspects relating to four-legged slaughter animals, the exterior surface includes the hide and/or hair of the animal. In certain aspects relating to poultry animals, the exterior surface includes feathers of the animal.

In certain preferable aspects, prior to application of one or more microbiocidally-effective compositions of the present invention to the live animal, areas such as animal hind quarters, legs, hooves, feet and other areas where fecal matter exists on the animals, are initially cleansed of fecal matter by hosing or use of sprays of at least water or aqueous detergent solutions.

Whether or not such preferred cleansing is conducted, pursuant to the present invention the live animal is exposed to spraying, showering, misting, partial bathing, or any other suitable method of applying at least one aqueous microbiocidally-effective composition of the present invention to exterior surfaces of the animal while it is still alive. Preferably such at least one aqueous microbiocidally-effective composition of the present invention is applied to substantially the entire animal before the animal enters the area where exsanguination (i.e., bleeding and thus killing) or evisceration is to occur. This can be accomplished, for example, by providing at least one shower zone and/or spray zone at a location where the animals are caused to move from holding areas toward the slaughterhouse or meat packing plant. As the animals pass through such zone or zones, they are showered and/or sprayed with one or more aqueous microbiocidally-effective compositions of this invention so that the exterior of the animal becomes wetted by such composition. Such sprays can be fixed or articulated sprays. Also, the shower and/or sprays can be of different intensities so as ensure thorough wetting of the hide or feathers and flushing of filth from the animal. Preferably, the animal is then caused to walk through a bath of aqueous microbiocidally-effective composition of this invention so that at least the lower leg area and hooves of the animal are washed by such composition. Such bath can include subsurface forced spray jets to improve washing efficiency. It is preferred to locate such bath outside of the slaughterhouse or meat packing plant, and/or at least in a perimeter area of the slaughterhouse or meat packing plant, as such positioning will help ensure that the amount of microbiocidal contamination brought into the slaughterhouse or meat packing plant is effectively minimized by practice of this invention. This in turn greatly reduces the likelihood of cross contamination during subsequent processing operations conducted in the slaughterhouse or meat packing plant.

Another Type I operation pursuant to the present invention is the application of mists of aqueous microbiocidally-effective composition to the animal in lieu of, or in addition to, sprays as the animal moves toward the slaughterhouse or meat packing plant, or in the case of poultry through the shackling line towards scalding. Also the sequence of passage through zones can be varied, e.g., causing the animal(s) to walk through a bath of aqueous microbiocidally-effective composition can occur before or at the same time one or more showers and/or sprays are applied to the animal. Another option is to provide a misting zone in which at least one aqueous microbiocidally-effective composition of this invention is applied to the animal after one or more zones where showering, spraying and/or bathing (in whatever sequence is desired) of the animal with at least one aqueous microbiocidally-effective composition of this invention take(s) place. In short, any sequence of applying at least one aqueous microbiocidally-effective composition of the present invention to the live animal can be used. Any such application preferably takes place as the animal is moved toward the slaughterhouse or meat packing plant and/or is in a perimeter area of the slaughterhouse or meat packing plant.

Where more than one live animal bathing zone, showering zone, spray zone, and/or misting zone is used pursuant to the present invention, the microbiocidally-effective concentrations of the respective aqueous microbiocidally-effective compositions of the present invention used in such zones can be the same or at least two such compositions can differ in concentration. The actual concentration ranges are typically in the ranges described above but can be increased to suit the needs of the occasion, such as in cases where animals have been exposed to extraordinary amounts of fecal matter due to unusual circumstances such as unanticipated microbiocidal contamination of a supply of animal feed or drinking water, sickness of some animals within a herd, transportation delays, or the like.

The temperature(s) of the aqueous microbiocidally-effective composition(s) used in the above Type I processing pursuant to the present invention can differ over a suitable range. Thus the composition(s) used can be applied after being heated to a suitable warm temperature or conversely cooled to a suitable cooling temperature to assist in calming the animals as they approach the slaughterhouse or meat packing plant, and thereby improve the movement of a procession of animals from the holding area to the slaughter house or meat packing plant and/or as they approach the stunning area. Also, by suitably adjusting the temperature of the composition(s) it is possible to prevent or at least reduce heat-related sickness (e.g., heat stroke) of stressed closely-packed animals.

According to certain aspects of the present invention relating to poultry animals, the aqueous microbiocidally-effective composition(s) used in the above Type I processing are applied to the poultry animal after it is shackled but prior to the stunning and/or slaughter stage. The poultry animal may be shackled and the line may move through a mist or shower bath prior to moving to the stunning and/or slaughter processes.

Among additional advantages of the above Type I processing is that the microbiocidal effectiveness of the aqueous microbiocidal compositions formed by mixing one or more N,N′-dichloro-5,5-dialkylhydantoin(s) and/or N,N′-dichloro-5-ethyl-5-methylimidazolidine-2,4-dione(s) with an aqueous medium is suitably high even when using low dosage levels of such compound(s). In some aspects, the N,N′-dichloro-5-ethyl-5-methylimidazolidine-2,4-dione comprises 1,3-dichloro-5-ethyl-5-methylimidazolidine-2,4-dione. This in turn avoids or at least minimizes the likelihood of adverse behavioral reaction of the animal if and when, for example, the spray is applied to the eyes or otherwise comes into contact with sensitive body parts of the animal. Avoidance or minimization of such adverse behavioral reaction of the animal is beneficial in that the movement of a procession of animals to the slaughterhouse or meat packing plant and/or to the stunning area is not disrupted.

In small abattoir operations where, periodically, only one or a relatively few animals are slaughtered, the above-described operations can be conducted in various ways. For example, the animal(s) can be sprayed by use of one or more hand held pressurized spraying devices each attached by a hose to a suitable supply of an aqueous microbiocidally-effective composition of this invention. Alternatively, the composition can be applied by use, for example, of mops, hand-held rags, sponges, or scrubbing brushes, and/or simply by splashing the live animal with the composition of this invention from a pail or bucket. In operations such as these, care should be taken to ensure that effective coverage of the exterior animal surfaces by the applied aqueous microbiocidally-effective composition of this invention is achieved. Also, as in any operation where portions of the operator(s) may be exposed over and over again to a chemical solution, it is desirable for the operator(s) to wear at least water-impermeable gloves and goggles, and preferably water-impermeable outer garments as well. As noted above, it is preferable to wash the animal with water before applying the aqueous microbiocidally-effective composition of this invention to the animal.

Other places in the slaughterhouse or meat packing plant where an aqueous microbiocidally-effective composition of this invention can be applied with desirable results to the animal while it is still alive are in the area where the animal is to be stunned and/or where the stunned animal is handled after stunning but before exsanguination is initiated. Such handling may include, for example, transporting and/or attaching the stunned animal to a conveyor system, or in the case of poultry animals a shackling conveyor. At such locations in the slaughterhouse or meat packing plant, application of an aqueous microbiocidally-effective composition of this invention to exterior surfaces of the stunned animal such as by means of a shower system, spray system, misting system or bath can be advantageous. Such an operation can be used in addition to or in place of the application of an aqueous microbiocidally-effective composition of this invention to exterior surfaces of the animal as it moves from the holding area toward the slaughterhouse or meat packing plant and/or is in a perimeter area of the slaughterhouse or meat packing plant, as described above. In all cases of Type I processing, it is preferred to ensure that the live animal has been thoroughly washed with water or aqueous detergent solution at least once before applying the aqueous microbiocidally-effective composition of this invention to the animal before it is killed.

It is also possible pursuant to the present invention to wash the live animal with water or aqueous detergent solution and thereafter apply to the animal while still alive, an aqueous mixture in which one or more surfactants, detergents, wetting agents, hydrotropes, thickeners, foaming agents, defoaming agents, buffering agents, acids, bases, demulcents, humectants, emollients, vitamins, fatty acids, or similar functional additives are included in an aqueous microbiocidally-effective composition of this invention, provided that the one or more additives are not susceptible to oxidation by N,N′-dichloro-5,5-dialkylhydantoin and/or N,N′-dichloro-5-ethyl-5-methylimidazolidine-2,4-dione. In certain aspects, the acid comprises at least one peroxycarboxylic acid having between 2 and 12 carbon atoms, the peroxycarboxylic acid being chosen from peroxyformic acid, peroxypropionic acid, peroxyacetic acid, peroxybutanoic acid, peroxypentanoic acid, peroxyhexanoic acid, peroxyheptanoic acid, peroxyoctanoic acid, peroxynonanoic acid, peroxydecanoic acid, peroxyundecanoic acid, peroxydodecanoic acid, peroxylactic acid, peroxymaleic acid, peroxyascorbic acid, peroxyhydroxyacetic acid, peroxyoxalic acid, peroxymalonic acid, peroxysuccinic acid, peroxyglutaric acid, peroxyadipic acid, peroxypimelic acid, peroxysubric acid, and mixtures thereof. Preferably, the intervention solution comprises an equilibrium peroxyacetic acid or a pH modified peroxyacetic acid.

The equilibrium peroxyacetic acid preferably has a pH above about 3.0 and below about 7.0, in some aspects about 3.5 to about 5.5, and in some other aspects about 3.5 to about 5.0, although subranges within these ranges is contemplated.

The pH modified peroxycarboxylic acid preferably has a pH above about 7.0 and below about 10.0, in certain aspects a pH range of about 7.0 to about 9.5, and in some other aspects a pH range of about 7.5 to about 9.0, although subranges within these ranges is contemplated. The pH modified peroxycarboxylic acid can be prepared by combining a peroxycarboxylic acid solution, such as a peroxyacetic acid solution, with one or more buffering agents chosen from sodium hydroxide, potassium hydroxide, the sodium salt of carbonic acid, the potassium salt of carbonic acid, phosphoric acid, silicic acid or mixtures thereof, in a quantity that is necessary to bring the solution to said pH range. One of ordinary skill in the art will appreciate that other alkalizing chemistries approved for direct food contact may also be used, whether alone or in combination with any of the foregoing buffering agents. The quantity of the buffering agent in a buffered peroxycarboxylic acid solution will generally be in the range of about 0.01% to about 10% by volume of the total solution, but other volumes of the buffering agent may be utilized depending upon various parameters, such as local water condition, including pH, hardness and conductivity.

### Type II Processing

As used anywhere herein including the claims, the term “carcass” denotes the body of the slaughtered four-legged slaughter animal or poultry animal at any stage of the processing operations used to convert the dead animal into meat. Thus the term “carcass” includes (i) the whole slaughtered animal body, (ii) parts of the animal body, (iii) the trunk of the body remaining after removal of the head and/or legs from the trunk of the animal, (iv) the severed head, severed legs themselves and/or severed wings themselves, and (v) the parts of the trunk of the body after it has been split in half, quarters or any other splitting.

As used anywhere herein including the claims, the term “during” denotes a period of time either (i) throughout the entire time a given operation is being conducted or (ii) at some portion or portions of the time a given operation is being conducted but not all of the time that such given operation is conducted. For example the phrase “during hide removal” means that some specified thing is done (i) at least throughout the entire time a hide removal operation is being carried out on a given carcass, or alternatively, (ii) for one or more time periods—but not throughout the entire time—a hide removal operation is being carried out on a given carcass. This would equally apply to “during feather removal” for a poultry animal. Note also that such hide/feather removal operation (or other specified operation) need not be continuous in the sense, for example, that the hide or all the feathers must be separated from the animal continuously from start to finish of the operation on a given carcass. Such removal can be continuous or non-continuous with pauses occurring during the overall operation (e.g., hide/feather removal), and thus the specified thing is done either (i) at least throughout the entire time a given operation is being carried out on a given carcass including any pauses that occur in such operation, or alternatively, (ii) for one or more time periods—but not throughout the entire time—a given operation is being carried out on a given carcass including any pauses that occur in such operation.

As used anywhere herein, including the claims, the term “product solution” denotes the aqueous solution that results from mixing together at least water and one or more N,N′-dichloro-5,5-dialkylhydantoin(s) and/or N,N′-dichloro-5-ethyl-5-methylimidazolidine-2,4-dione(s). In certain aspects, the term “product solution” denotes the aqueous solution that results from mixing together at least water and 1,3,-dichloro-5,5,-dimethylhydantoin and/or 1,3-dichloro-5-ethyl-5-methylimidazolidine-2,4-dione. According to present theoretical concepts, N,N′-dichloro-5,5-dialkylhydantoin(s) and/or N,N′-dichloro-5-ethyl-5-methylimidazolidine-2,4-dione(s), to at least some extent, lose their original chemical structure when dissolved in an aqueous medium and the resultant composition, whatever it may be, is denoted herein as a “product solution” as it is formed from such specified components.

As used anywhere herein including the claims, the term “directly precedes” means that the specified thing (e.g., contacting a carcass with an aqueous microbiocidal composition) is done before the ensuing operation (e.g., hide or skin removal or feather removal) has begun without any intervening operation being conducted except for transporting the carcass from the place where the specified thing was conducted to the place where the ensuing operation is to be done.

Pursuant to certain aspects of the present invention, the external surfaces of a non-eviscerated carcass of at least one four-legged slaughter animal or poultry animal can be contacted at least once with an aqueous microbiocidally-effective composition of the present invention. This contacting can be effected by immersing the carcass in an aqueous microbiocidally-effective composition, by showering, spraying or misting the carcass with an aqueous microbiocidally-effective composition, or by using any other method of applying the aqueous microbiocidally-effective composition of the present invention so that it comes into direct contact with the carcass before, during and/or after hide removal, hair and/or bristle removal, or feather removal (depending upon the respective animal carcass), but in each case prior to evisceration. Thus in the case of animal processing where the hide is removed followed by evisceration with or without an intermediate water wash, the contacting step with the intervention solution should take place before, during and/or after the hide removal stage but before the evisceration operation commences. In the case of animal processing where the hide is not removed before evisceration (e.g., where the carcass is subjected to singeing or shearing to remove hair and/or bristles, followed by evisceration, with or without an intermediate water wash), the contacting usually should take place after the singeing or shearing but before the evisceration operation commences. It is also possible to cause the contacting to occur during hair and/or bristle removal when the removal is conducted by a method other than singeing. In either such case (i.e., where hide is removed or where hide is not removed before evisceration), in a moving line of suspended spaced-apart carcasses, the contacting should be conducted such that the exposed surfaces of each carcass are contacted with and remain in contact with the aqueous microbiocidal solution used pursuant to the present invention for a period of at least 2 seconds, and preferably for a period of at least 30 seconds. Also in either such case the aqueous microbiocidally-effective composition of the present invention can be preheated so that as applied to the carcass before evisceration the solution, spray or mist is at a temperature above room temperature but not higher than about 70° C., and preferably not higher than about 39° C. Since such heating does not materially diminish the biocidal activity of the aqueous microbiocidally-effective compositions of this invention, the ability to so heat such compositions ensures that customary processing line speeds in automated slaughterhouses will not be unduly compromised.

In the case of a poultry animal, the contacting should take place after the feather removal step but before the evisceration operation commences. It is also possible to cause the contacting to occur during feather removal. In either such case, in a moving shackle line of suspended spaced-apart carcasses, the contacting should be conducted such that the exposed surfaces of each carcass are contacted with and remain in contact with the aqueous microbiocidal solution used pursuant to the present invention for a period of at least 2 seconds, and preferably for a period of at least 30 seconds. Also in either such case the aqueous microbiocidally-effective composition of the present invention can be preheated so that as applied to the carcass before evisceration the solution, spray or mist is at a temperature above room temperature but not higher than about 70° C., and preferably not higher than about 39° C. Since such heating does not materially diminish the biocidal activity of the aqueous microbiocidally-effective compositions of this invention, the ability to so heat such compositions ensures that customary processing line speeds in automated slaughterhouses will not be unduly compromised.

When applying an aqueous microbiocidally-effective composition of the present invention to an animal carcass during hide removal or feather removal, it is convenient to employ either spraying or misting as the method of application. In this way the customary hide removal or feather removal operations need not be materially altered in order to accommodate the application of the aqueous microbiocidally-effective composition of the present invention to the carcass during hide removal or feather removal.

In certain aspect of the present invention, a series of spaced-apart suspended non-eviscerated animal carcasses are passed into a spray zone such as one or more cabinets or shower stall areas fitted with nozzles and/or spray heads that direct at least one spray or shower, preferably a plurality of sprays, of an aqueous microbiocidally-effective composition of the present invention onto the surfaces of at least one carcass at a time as it passes through the spray zone. The coverage of the sprays should ensure that the surfaces of the suspended carcass are all exposed to, and come into contact with, the aqueous microbiocidally-effective composition of the present invention. In the case of four-legged animals, the non-eviscerated carcasses entering the spray zone will either have been skinned (i.e., the hide has been removed) or the hide or skin will remain intact but hair and/or bristles will have been removed from the carcass typically by singeing, shearing or other suitable hair and/or bristle removal technique, the choice between skinning and hair and/or bristle removal depending on the kind of animals being processed. For example, with cattle the hide will typically be removed prior to entry of the carcass into the spray zone for antimicrobial treatment of this invention with an aqueous microbiocidally-effective composition of this invention, whereas with swine, the carcass will typically be singed to burn off surface hair and/or bristles prior to entry of the carcass into the spray zone for such treatment. In the case of poultry animals, the non-eviscerated carcasses entering the spray zone will have the feathers removed and the skin intact. After the carcass exits the spray zone, typically the carcass will be washed with rinse water by any suitable technique such as dipping, spraying, submerging, etc., and then eviscerated, or will be subjected to evisceration as the next step in the processing without an intervening water wash.

In still other aspects of the present invention, an aqueous microbiocidally-effective composition of the present invention is applied to the animal carcass during evisceration. In order to minimize the possibility of interfering with the normal or conventional evisceration procedure, it is preferable to apply the aqueous microbiocidally-effective composition of the present invention to the carcass as a mist or as a low-pressure fine spray during most if not all of the time the carcass is being eviscerated. Such misting or fine spraying ensures that the carcass and the entrails are both thoroughly wetted by the aqueous microbiocidally-effective composition of the present invention without at the same time impairing the effectiveness of the operation. A particular advantage of application during evisceration is that microbial or bacterial contamination in the event of rupture of entrails is promptly combated by the presence and continuous application of the highly effective aqueous microbiocidal composition of the present invention. As a consequence, contamination of ensuing carcasses by such microbial or bacterial contamination can be avoided without shutting the line down. As an adjunct, the entrails after removal can be transported or conveyed to a washing zone where the entrails are submerged in a bath of an aqueous microbiocidally-effective composition of this invention for a period sufficient to ensure effective microbial and bacterial control.

In other aspects of the present invention, an inside-outside carcass washing of the eviscerated carcass is conducted prior to and/or during and/or after the carcass splitting or trimming operation. In conducting such inside-outside carcass washing pursuant to the present invention, it is preferred to use a spray delivery system such as a probe, bayonet or other spray nozzle system that applies a pressurized spray of the aqueous microbiocidally-effective composition of the present invention to the interior cavity of the carcass and another spray delivery system such as a series of nozzles, which system applies the aqueous microbiocidally-effective composition of the present invention to the exterior of the carcass. In certain aspects, the aqueous microbiocidally-effective composition of the present invention applied by the spray delivery system to the interior cavity of the carcass has a higher concentration of microbiocide formed from N,N′-dichloro-5,5-dialkylhydantoin(s) and/or N,N′-dichloro-5-ethyl-5-methylimidazolidine-2,4-dione(s) than the concentration of the microbiocide formed from the N,N′-dichloro-5,5-dialkylhydantoin(s) and/or N,N′-dichloro-5-ethyl-5-methylimidazolidine-2,4-dione(s) in the water applied by the spray delivery system to the exterior the carcass. The N,N′-dichloro-5,5-dialkylhydantoin(s) and/or N,N′-dichloro-5-ethyl-5-methylimidazolidine-2,4-dione(s) used for forming the microbiocidal content in the water used for washing the interior cavity of the carcass and the N,N′-dichloro-5,5-dialkylhydantoin(s) and/or N,N′-dichloro-5-ethyl-5-methylimidazolidine-2,4-dione(s) used for forming the microbiocidal content of the water used for washing the exterior of the carcass can be, and usually will be, of the same chemical composition. However, N,N′-dichloro-5,5-dialkylhydantoin(s) and/or N,N′-dichloro-5-ethyl-5-methylimidazolidine-2,4-dione(s) of different chemical composition can be used for forming these respective aqueous microbiocidally-effective compositions of the present invention for such inside-outside washing.

In certain aspects of the present invention, a plurality of suspended eviscerated animal carcasses being conveyed or otherwise transported into a cooling zone and/or after they have been received in a cooling zone are subjected while still warm (i.e., the carcasses have not lost all of the original body heat of the animal while alive) to at least one spray, shower, or mist of an aqueous microbiocidally-effective composition of the present invention so that such composition comes into contact with both the inside and the outside of the carcass. When the suspended carcass is being transported toward the cooling zone, the spraying, showering, or misting of the traveling carcass can be effected within one or more suitable spray or misting cabinets or within one or more shower stalls or shower zones. Optionally, rinse water may be applied after application of the aqueous microbiocidally-effective composition of the present invention. When the carcass is within the cooling zone, typically in a stationary fixed or rotatable position, such spraying, showering, or misting can be conducted continuously for a single suitable period of time, but preferably such sprays, showers, or mists can be periodically applied to the carcass. This preferred embodiment is particularly advantageous for use in the processing of cattle where carcasses are typically aged in a cooling zone for periods in the range of about 6 to about 48 hours. The application of such sprays, showers, or mists, especially if conducted periodically during the aging period, not only effectively prevents microbial development and growth, but keeps the meat from losing tenderness. In sharp contrast, application of a spray, shower, or mist of plain water during aging in a cooling zone in order to keep the meat from drying out and becoming tough, tends to result in an explosive growth of bacterial population. In the case of poultry animals, the carcass can be transported to a chilling bath comprising an aqueous microbiocidally-effective composition of the present invention.

Another feature of the present invention is that the suspended eviscerated animal carcasses as they are being conveyed or otherwise transported into a chilling bath, cooling zone and/or after they have been received in a cooling zone can be sprayed, showered, or misted with an aqueous microbiocidally-effective composition of this invention that is itself at a low temperature of about 15° C. or below and preferably at about 10° C. or below, and more preferably at a temperature at about 7° C. or below, in some aspects about 4° C., but in all cases above the freezing temperature of the microbiocidal solution. It can be seen therefore that in this operation the cold spray, shower, or mist used serves several functions. First of all, the cold spray, shower, or mist applied to these carcasses provides excellent microbial and/or bacterial control even though used at such low temperatures. Secondly the cold spray, shower, or mist when applied to the carcasses as they are being conveyed or otherwise transported into a chilling tank, cooling zone and/or shortly after they have been received in a cooling zone assists in chilling the carcasses. Thirdly, the cold spray, shower, or mist when applied to the carcasses that have already been chilled sufficiently so as to be at the desired low temperature, will not materially increase the temperature of the chilled carcasses. In all cases the coverage of the sprays, showers, or mists should ensure that the surfaces of the suspended carcass are exposed to the aqueous microbiocidally-effective composition of the present invention.

Pursuant to other aspects of the presents invention, effective microbiocidal control in the processing of four-legged slaughter animals, especially cattle or swine, or poultry animals is brought about by use of an aqueous microbiocidally-effective composition of the present invention in at least two of three important animal processing stages or stations, whereby without materially affecting productivity, more effective microbiocidal control is achieved as compared to use of hypochlorite or various other chlorine-derived microbiocides.

More particularly, pursuant to certain aspects of the present invention, water treated with at least one N,N′-dichloro-5,5-dialkylhydantoin and/or N,N′-dichloro-5-ethyl-5-methylimidazolidine-2,4-dione to form an aqueous microbiocidally-effective composition of the present invention is brought into contact with the carcass of a four-legged slaughter animal during at least two of the following three operations: (1) before, during and/or after hide removal or before and/or after hair and/or bristle removal, and in some cases during hair and/or bristle removal by methods other than singeing, (2) during evisceration, and (3) immediately prior to and/or during chilling. Methods for carrying out each of these three operations have been described hereinabove.

More particularly, pursuant to certain aspects of the present invention, water treated with at least one N,N′-dichloro-5,5-dialkylhydantoin and/or N,N′-dichloro-5-ethyl-5-methylimidazolidine-2,4-dione to form an aqueous microbiocidally-effective composition of the present invention is brought into contact with the carcass of a poultry animal during at least two of the following three operations: (1) before, during and/or after feather removal, (2) during evisceration, and (3) immediately prior to and/or during chilling. Methods for carrying out each of these three operations have been described hereinabove.

In certain aspects of the present invention, an aqueous microbiocidally-effective composition of the present invention is utilized in at least two, preferably at least three, more preferably at least four, and most preferably in at least five of the following operations for a state-of-the-art slaughter house in the processing of cattle: (1) hide removal, (2) disinfection between hide removal and prior to evisceration, (3) evisceration, (4) carcass splitting, (5) final wash, and (6) chill. Operations other than (2) are typically carried out in state-of-the-art slaughterhouses in the processing of cattle, but of course without using an aqueous microbiocidally-effective composition of this invention in any operation. Operation (2) is an operation believed to be unique to this invention. Methods for carrying out operations (1), (2), (3), (4), and (6) in accordance with the present invention have been described hereinabove. In operation (5), i.e., the final wash operation, any conventional way of carrying out such an operation can be used pursuant to this invention simply by including in some or all of the wash water an aqueous microbiocidally-effective composition of this invention.

In certain other aspects of the present invention, an aqueous microbiocidally-effective composition of the present invention is utilized in at least two, preferably at least three, and most preferably in all four of the following operations: utilized in a state-of-the-art slaughter house in the processing of swine: (1) disinfection between hair and/or bristle and/or skin removal and prior to evisceration, (2) evisceration, (3) splitting, and (4) chill. Operations other than (1) are typically carried out in state-of-the-art slaughterhouses in the processing of swine, but of course without using an aqueous microbiocidally-effective composition of this invention in any operation. Operation (1) is an operation believed to be unique to this invention. Methods for carrying out operations (1), (2), (3), and (4) in accordance with this invention have been described hereinabove.

In conducting spraying operations pursuant to the present invention in one or more of the various stages or locations in an animal carcass processing line, the nozzles used for applying the aqueous microbiocidally-effective composition of the present invention to the animal carcass can be fixed or articulating nozzles. In addition, during spraying, showering or misting steps used in the practice of the present invention, rotary brushes or other ways of increasing contact between the aqueous microbiocidally-effective composition of this invention and the carcass, such as use of ultrasonic energy, can be used. Thereafter the carcass can be rinsed with clear water, if deemed necessary or desirable. Such rinsing water can be fresh or recirculated water, or a combination of both. The recirculated water should be effectively purged of residual impurities from prior usage.

### Type III Processing

Pursuant to certain aspects of the present invention, the external surfaces of an eviscerated carcass of at least one four-legged slaughter animal or poultry animal can be contacted at least once with an aqueous microbiocidally-effective composition of the present invention. This contacting can be effected by immersing the carcass in an aqueous microbiocidally-effective composition, by showering, spraying or misting the carcass with an aqueous microbiocidally-effective composition, or by using any other method of applying the aqueous microbiocidally-effective composition of the present invention so that it comes into direct contact with the carcass before, during and/or after evisceration. Thus in the case of animal processing where the hide is removed followed by evisceration with or without an intermediate water wash, the contacting step with the intervention solution should take place before, during and/or after the hide removal stage but after the evisceration operation commences. In the case of animal processing where the hide is not removed before evisceration (e.g., where the carcass is subjected to singeing or shearing to remove hair and/or bristles, followed by evisceration, with or without an intermediate water wash), the contacting usually should take place after the singeing or shearing and after the evisceration operation commences. It is also possible to cause the contacting to occur during hair and/or bristle removal when the removal is conducted by a method other than singeing. In either such case (i.e., where hide is removed after evisceration), in a moving line of suspended spaced-apart carcasses, the contacting should be conducted such that the exposed surfaces of each carcass are contacted with and remain in contact with the aqueous microbiocidal solution used pursuant to the present invention for a period of at least 2 seconds, and preferably for a period of at least 30 seconds. Also in either such case the aqueous microbiocidally-effective composition of the present invention can be preheated so that as applied to the carcass after evisceration the solution, spray or mist is at a temperature above room temperature but not higher than about 70° C., and preferably not higher than about 39° C. Since such heating does not materially diminish the biocidal activity of the aqueous microbiocidally-effective compositions of this invention, the ability to so heat such compositions ensures that customary processing line speeds in automated slaughterhouses will not be unduly compromised.

In the case of a poultry animal, the contacting should take place after the feather removal and after the evisceration operation commences. In a moving shackle line of suspended spaced-apart carcasses, the contacting should be conducted such that the exposed surfaces of each carcass are contacted with and remain in contact with the aqueous microbiocidal solution used pursuant to the present invention for a period of at least 2 seconds, and preferably for a period of at least 30 seconds. Also in either such case the aqueous microbiocidally-effective composition of the present invention can be preheated so that as applied to the carcass after evisceration the solution, spray or mist is at a temperature above room temperature but not higher than about 70° C., and preferably not higher than about 39° C. Since such heating does not materially diminish the biocidal activity of the aqueous microbiocidally-effective compositions of this invention, the ability to so heat such compositions ensures that customary processing line speeds in automated slaughterhouses will not be unduly compromised.

When applying an aqueous microbiocidally-effective composition of the present invention to an animal carcass after a chilling stage, such as a chilling tank, it is convenient to employ either a dipping, spraying or misting as the method of application with the aqueous microbiocidally-effective composition applied at about the same temperature as the chilled carcass. In this way, the carcass temperature need not be materially altered in order to accommodate the application of the aqueous microbiocidally-effective composition of the present invention to the carcass after the chilling stage.

In a moving shackle line of suspended spaced-apart carcasses, the contacting should be conducted such that the exposed surfaces of each carcass are contacted with and remain in contact with the aqueous microbiocidal solution used pursuant to the present invention for a period of at least 2 seconds, and preferably for a period of at least 30 seconds.

In certain aspect of the present invention, a series of spaced-apart suspended eviscerated animal carcasses are passed into a spray zone such as one or more cabinets or shower stall areas fitted with nozzles and/or spray heads that direct at least one spray or shower, preferably a plurality of sprays, of an aqueous microbiocidally-effective composition of the present invention onto the surfaces of at least one carcass at a time as it passes through the spray zone. The coverage of the sprays should ensure that the surfaces of the suspended carcass are all exposed to, and come into contact with, the aqueous microbiocidally-effective composition of the present invention. In the case of four-legged animals, the eviscerated carcasses entering the spray zone will either have been skinned (i.e., the hide has been removed) or the hide or skin will remain intact but hair and/or bristles will have been removed from the carcass typically by singeing, shearing or other suitable hair and/or bristle removal technique, the choice between skinning and hair and/or bristle removal depending on the kind of animals being processed. For example, with cattle the hide will typically be removed prior to entry of the carcass into the spray zone for antimicrobial treatment of this invention with an aqueous microbiocidally-effective composition of this invention, whereas with swine, the carcass will typically be singed to burn off surface hair and/or bristles prior to entry of the carcass into the spray zone for such treatment. In the case of poultry animals, the eviscerated carcasses entering the spray zone will have the feathers removed and the skin intact. After the carcass exits the spray zone, typically the carcass will be washed with rinse water by any suitable technique such as dipping, spraying, submerging, etc.

In other aspects of the present invention, an inside-outside carcass washing of the eviscerated carcass is conducted prior to and/or during and/or after the carcass splitting or trimming operation. In conducting such inside-outside carcass washing pursuant to the present invention, it is preferred to use a spray delivery system such as a probe, bayonet or other spray nozzle system that applies a pressurized spray of the aqueous microbiocidally-effective composition of the present invention to the interior cavity of the carcass and another spray delivery system such as a series of nozzles, which system applies the aqueous microbiocidally-effective composition of the present invention to the exterior of the carcass. In certain aspects, the aqueous microbiocidally-effective composition of the present invention applied by the spray delivery system to the interior cavity of the carcass has a higher concentration of microbiocide formed from N,N′-dichloro-5,5-dialkylhydantoin(s) and/or N,N′-dichloro-5-ethyl-5-methylimidazolidine-2,4-dione(s) than the concentration of the microbiocide formed from the N,N′-dichloro-5,5-dialkylhydantoin(s) and/or N,N′-dichloro-5-ethyl-5-methylimidazolidine-2,4-dione(s) in the water applied by the spray delivery system to the exterior the carcass. The N,N′-dichloro-5,5-dialkylhydantoin(s) and/or N,N′-dichloro-5-ethyl-5-methylimidazolidine-2,4-dione(s) used for forming the microbiocidal content in the water used for washing the interior cavity of the carcass and the N,N′-dichloro-5,5-dialkylhydantoin(s) and/or N,N′-dichloro-5-ethyl-5-methylimidazolidine-2,4-dione(s) used for forming the microbiocidal content of the water used for washing the exterior of the carcass can be, and usually will be, of the same chemical composition. However, N,N′-dichloro-5,5-dialkylhydantoin(s) and/or N,N′-dichloro-5-ethyl-5-methylimidazolidine-2,4-dione(s) of different chemical composition can be used for forming these respective aqueous microbiocidally-effective compositions of the present invention for such inside-outside washing.

In certain aspects of the present invention, a plurality of suspended eviscerated animal carcasses being conveyed or otherwise transported into a cooling zone and/or after they have been received in a cooling zone are subjected while still warm (i.e., the carcasses have not lost all of the original body heat of the animal while alive) to at least one spray, shower, or mist of an aqueous microbiocidally-effective composition of the present invention so that such composition comes into contact with both the inside and the outside of the carcass. When the suspended carcass is being transported toward the cooling zone, the spraying, showering, or misting of the traveling carcass can be effected within one or more suitable spray or misting cabinets or within one or more shower stalls or shower zones. Optionally, rinse water may be applied after application of the aqueous microbiocidally-effective composition of the present invention. When the carcass is within the cooling zone, typically in a stationary fixed or rotatable position, such spraying, showering, or misting can be conducted continuously for a single suitable period of time, but preferably such sprays, showers, or mists can be periodically applied to the carcass. This preferred embodiment is particularly advantageous for use in the processing of cattle where carcasses are typically aged in a cooling zone for periods in the range of about 6 to about 48 hours. The application of such sprays, showers, or mists, especially if conducted periodically during the aging period, not only effectively prevents microbial development and growth, but keeps the meat from losing tenderness. In sharp contrast, application of a spray, shower, or mist of plain water during aging in a cooling zone in order to keep the meat from drying out and becoming tough, tends to result in an explosive growth of bacterial population. In the case of poultry animals, the carcass can be transported to a chilling bath comprising an aqueous microbiocidally-effective composition of the present invention.

Another feature of the present invention is that the suspended eviscerated animal carcasses as they are being conveyed or otherwise transported into a chilling bath, cooling zone and/or after they have been received in a cooling zone can be sprayed, showered, or misted with an aqueous microbiocidally-effective composition of this invention that is itself at a low temperature of about 15° C. or below and preferably at about 10° C. or below, and more preferably at a temperature at about 7° C. or below, in some aspects about 4° C., but in all cases above the freezing temperature of the microbiocidal solution. It can be seen therefore that in this operation the cold spray, shower, or mist used serves several functions. First of all, the cold spray, shower, or mist applied to these carcasses provides excellent microbial and/or bacterial control even though used at such low temperatures. Secondly the cold spray, shower, or mist when applied to the carcasses as they are being conveyed or otherwise transported into a chilling tank, cooling zone and/or shortly after they have been received in a cooling zone assists in chilling the carcasses. Thirdly, the cold spray, shower, or mist when applied to the carcasses that have already been chilled sufficiently so as to be at the desired low temperature, will not materially increase the temperature of the chilled carcasses. In all cases the coverage of the sprays, showers, or mists should ensure that the surfaces of the suspended carcass are exposed to the aqueous microbiocidally-effective composition of the present invention.

Another feature of the present invention is that the eviscerated animal carcasses as they are being conveyed or otherwise transported from the chilling bath, cooling zone and/or after they have been received and cooled in a cooling zone can be sprayed, showered, or misted with an aqueous microbiocidally-effective composition of this invention that is itself at a low temperature of about 15° C. or below and preferably at about 10° C. or below, and more preferably at a temperature at about 7° C. or below, in some aspects about 4° C., but in all cases above the freezing temperature of the microbiocidal solution. It can be seen therefore that in this operation the cold spray, shower, or mist used serves several functions. First of all, the cold spray, shower, or mist applied to these carcasses provides excellent microbial and/or bacterial control even though used at such low temperatures. Secondly the cold spray, shower, or mist when applied to the carcasses as they are being conveyed or otherwise transported out of the chilling tank, cooling zone and/or shortly after they have been received in a cooling zone assists in maintaining the carcasses at a chilled state. Thirdly, the cold spray, shower, or mist when applied to the carcasses that have already been chilled sufficiently so as to be at the desired low temperature, will not materially increase the temperature of the chilled carcasses. In all cases the coverage of the sprays, showers, or mists should ensure that the surfaces of the suspended carcass are exposed to the aqueous microbiocidally-effective composition of the present invention.

Pursuant to other aspects of the presents invention, effective microbiocidal control in the processing of four-legged slaughter animals, especially cattle or swine, or poultry animals is brought about by use of an aqueous microbiocidally-effective composition of the present invention in at least two of three important animal processing stages or stations, whereby without materially affecting productivity, more effective microbiocidal control is achieved as compared to use of hypochlorite or various other chlorine-derived microbiocides.

More particularly, pursuant to certain aspects of the present invention, water treated with at least one N,N′-dichloro-5,5-dialkylhydantoin and/or N,N′-dichloro-5-ethyl-5-methylimidazolidine-2,4-dione to form an aqueous microbiocidally-effective composition of the present invention is brought into contact with the carcass of a four-legged slaughter animal after chilling.

More particularly, pursuant to certain aspects of the present invention, water treated with at least one N,N′-dichloro-5,5-dialkylhydantoin and/or N,N′-dichloro-5-ethyl-5-methylimidazolidine-2,4-dione to form an aqueous microbiocidally-effective composition of the present invention is brought into contact with the carcass of a poultry animal after chilling.

In certain aspects of the present invention, an aqueous microbiocidally-effective composition of the present invention is utilized in at least two, preferably at least three, more preferably at least four, and most preferably in at least five of the following operations for a state-of-the-art slaughter house in the processing of cattle: (1) hide removal, (2) disinfection between hide removal and prior to evisceration, (3) evisceration, (4) carcass splitting, (5) final wash, (6) chill, and (7) post-chill. Operations other than (2) are typically carried out in state-of-the-art slaughterhouses in the processing of cattle, but of course without using an aqueous microbiocidally-effective composition of this invention in any operation. Operation (2) is an operation believed to be unique to this invention. Methods for carrying out operations (1), (2), (3), (4), (6) and (7) in accordance with the present invention have been described hereinabove. In operation (5), i.e., the final wash operation, any conventional way of carrying out such an operation can be used pursuant to this invention simply by including in some or all of the wash water an aqueous microbiocidally-effective composition of this invention.

In certain other aspects of the present invention, an aqueous microbiocidally-effective composition of the present invention is utilized in at least two, preferably at least three, and most preferably in all four of the following operations: utilized in a state-of-the-art slaughter house in the processing of swine: (1) disinfection between hair and/or bristle and/or skin removal and prior to evisceration, (2) evisceration, (3) splitting, (4) chill, and (5) post-chill. Operations other than (1) are typically carried out in state-of-the-art slaughterhouses in the processing of swine, but of course without using an aqueous microbiocidally-effective composition of this invention in any operation. Operation (1) is an operation believed to be unique to this invention. Methods for carrying out operations (1), (2), (3), (4) and (5) in accordance with this invention have been described hereinabove.

In conducting spraying operations pursuant to the present invention in one or more of the various stages or locations in an animal carcass processing line, the nozzles used for applying the aqueous microbiocidally-effective composition of the present invention to the animal carcass can be fixed or articulating nozzles. In addition, during spraying, showering or misting steps used in the practice of the present invention, rotary brushes or other ways of increasing contact between the aqueous microbiocidally-effective composition of this invention and the carcass, such as use of ultrasonic energy, can be used. Thereafter the carcass can be rinsed with clear water, if deemed necessary or desirable. Such rinsing water can be fresh or recirculated water, or a combination of both. The recirculated water should be effectively purged of residual impurities from prior usage.

### Type IV Processing

This type of processing pursuant to the present invention comprises contacting raw meat products and/or processed meat products derived from the slaughtered animal(s), with an aqueous microbiocidal composition formed by mixing at least one N,N′-dichloro-5,5-dialkylhydantoin and/or N,N′-dichloro-5-ethyl-5-methylimidazolidine-2,4-dione with an aqueous medium to form an aqueous microbiocidally-effective composition. This contacting should occur at one or more suitable stages before, during and/or after the formation or preparation of such raw meat and/or meat products. The methods of applying an aqueous microbiocidally-effective composition of the present invention to the raw meat and/or meat products are much the same as described above. Thus spraying, dipping, bathing, showering or like operations can be used. Also, in small slaughter houses or meat packing plants, hand-held sponges or washing cloths may be used for applying the aqueous microbiocidally-effective composition of the present invention. The raw meat products and/or processed meat products or precursors thereof, can be conveyed by automated conveying equipment such as conveyor belts on which such products or precursors are carried and transported, or moving tracks, belts, or cables by which such products or precursors are suspended, carried, and transported.

The raw meat that can be contacted with an aqueous microbiocidally-effective composition of the present invention can be in any form typically derived from the animal carcass. Non-limiting examples of such raw meat products include (a) meat cuts as for example breasts, steaks, chops, rib sections, meat roast cuts, hams, loins, bacon, trims, legs, wings, and other similar cuts, (b) animal organs such as liver, kidney, tripe, chitlins, tongue, and other organs or organ parts, and (c) ground raw meat such as ground turkey, ground chicken, ground beef, ground pork, raw meat sausages, and the like. Non-limiting examples of processed meat products that can be contacted with an aqueous microbiocidally-effective composition of this invention include ready-to-eat deli products, sausages, frankfurters, sliced meats, jerky, and/or other processed meat products.

Preferred raw meat products to which an aqueous microbiocidally-effective composition of the present invention is applied include red meat, red meat parts, white meat, white meat parts, dark meat, and dark meat parts. Most preferred is the application of an aqueous microbiocidally-effective composition of this invention to raw red meat (beef) from cattle, raw white meat (pork) from swine, or raw poultry meat (chicken or turkey).

In Type III processing, the aqueous microbiocidally-effective composition of this invention used will be a composition formed by mixing water and at least one N,N′-dichloro-5,5-dialkylhydantoin and/or N,N′-dichloro-5-ethyl-5-methylimidazolidine-2,4-dione microbiocidal agent in an amount in the range of about 0.5 to about 400 ppm (wt/wt) as free chlorine The particular concentration of the one or more N,N′-dichloro-5,5-dialkylhydantoin(s) and/or N,N′-dichloro-5-ethyl-5-methylimidazolidine-2,4-dione(s) used in forming such compositions, will vary depending upon the particular raw meat product and/or processed meat product being produced. In many cases such as in the treatment of raw meat cuts and ground or sliced meat products, the concentration of the N,N′-dichloro-5,5-dialkylhydantoin and/or N,N′-dichloro-5-ethyl-5-methylimidazolidine-2,4-dione microbiocidal agent used in forming the composition used, will be at the lower end of this range; for example, in the range of about 0.5 to about 100 ppm (wt/wt) as free chlorine and in some case as low as in the range of about 0.5 to about 50 ppm (wt/wt) as free chlorine

### EXAMPLES

### Example 1—DCDMH Efficacy

The following working examples are intended to be illustrative in nature and not intended to be limiting. One of ordinary skill in the art will recognize that the subject matter hereof may comprise fewer features or the subject matter hereof is exemplary of the foregoing written disclosure. The working examples described herein are not meant to be an exhaustive presentation of the ways in which the various features of the subject matter hereof may be combined or applied.

In the following working example, a study was conducted to compare the antimicrobial efficacy of 1,3,-dichloro-5,5,-dimethylhydantoin (DCDMH) and 1,3,-dibromo-5,5,-dimethylhydantoin (DBDMH) at 200 ppm available chlorine on both chicken and beef test substrates. For sample preparation, chicken legs and beef cubes obtained from a local grocery store were used to conduct the following tests. Prior to exposure of the test substrates to the antimicrobial solutions having DCDMH or DBDMH, the test substrates were exposed for two hours in 300 mL of broth of Salmonella Enterica serovar enteriditis (SE), which had been grown to a concentration of >6 log 10 in Nutrient Broth for 2 h at 35° C. Following exposure, the test substrates were removed from the Nutrient Broth and allowed to drain and air dry for about 30 minutes at ambient room temperature before testing began.

### Test Protocol

1. The following solutions were prepared and distributed in 200 mL aliquots into Ziploc bags:

a. 200 ppm available chlorine solutions derived from DCDMH distributed it into an appropriate number of Ziploc bags;

b. FSIS new buffer solution containing Lecithin and Sodium thiosulfate (LST) into an appropriate number of Ziploc bags;

c. Phosphate Buffer Solution (PBS) into an appropriate number of Ziploc bags.

2. Into each bag of DCDMH solution, a Salmonella-contaminated test substrate was placed and agitated manually for 15 s. The test substrate was removed from the bag, allowed to drip for 15 s, then placed into a Ziploc bag containing 200 mL LST. The bag was then vigorously shaken for 45 s to neutralize the DCDMH and to release SE from the surface of the chicken leg.

3. After the bags were shaken, 100 μL from each of the shaken bags was removed and dispensed into test tubes containing 9.9 mL of DI HOH. The contents of these tubes were used for serial dilution.

4. As controls, a prepared test substrate was inserted into each of two bags of PBS and agitated manually for 15 s. The substrate was removed from the bag and placed directly into a Ziploc bag containing 200 mL LST. The bag was vigorously shaken for 45 s to release SE from the surface of the substrate.

5. Repeat Step 3 with the control solutions.

6. Serially dilute the contents of the test tubes from Step 3 above. Plate 100 μL aliquots on Salmonella-Shigella Agar (SSA), then incubate for 18-24 h at 35° C. Enumerate colonies that have black centers (presumptive SE) after incubation.

7. Repeat the entire protocol replacing the DCDMH solution with DSBSMH solution in Step 1.a.

TABLE 1
Results of the antimicrobial efficacy of 1,3,-dichloro-5,5,-
dimethylhydantoin (DCDMH) and 1,3,-dibromo-5,5,-
dimethylhydantoin (DBDMH) at 200 ppm available
chlorine on both chicken and beef test substrates.

| Antimicrobial | Test | | |
|---|---|---|---|
| Chemistry | Substrate | Dilution ppm Ave. Cl | log Reduction Ave. |
| DCDMH | chicken | 200 | 0.64 |
| DBDMH | chicken | 200 | 0.29 |
| DCDMH | beef | 200 | 0.51 |
| DBDMH | beef | 200 | 0.15 |

The foregoing working example, made rigorous by the short contact time of test substrate with antimicrobial chemistry, clearly demonstrates that DCDMH has a substantially greater antimicrobial efficacy against S. Enteritidis than does DBDMH. Under normal in-plant use conditions it is anticipated that efficacy in excess of a 1 log reduction would be easily achievable.

### Example 2—DCDMH Concentration Efficacy on Red Meat

In the following working example, a study was conducted to compare the antimicrobial efficacy of 1,3,-dichloro-5,5,-dimethylhydantoin (DCDMH) at various concentrations (100 ppm, 200 ppm, and 400 ppm) on beef test substrates from beef brisket and beef liver. For sample preparation, beef brisket and beef liver were cubed to have approximately 25-30 cm³ of exposed surface. Prior to exposure of the test substrates to the antimicrobial solutions having DCDMH, the test substrates were incubated for two hours in 300 mL of broth of Salmonella Enterica serovar enteriditis (SE), which had been grown to a concentration of >6 log 10 in Nutrient Broth for 2 h at 35° C. Following exposure, the test substrates were removed from the Nutrient Broth and allowed to drain and air dry for about 30 minutes at ambient room temperature before testing began. The test was replicated 10 times for each concentration and two controls. The concentration of DCDMH was then tested on the exposed test substrates using spray and dip applications.

### Test Protocol—Spray Application

1. A test substrate cube was suspended on a stainless steel hook and the antimicrobial solution was atomized onto the cube to thoroughly cover all sides until solution was dripping from the test substrate cube, which was for about 5 to about 10 seconds;

2. The test substrate cube was allowed to drip for about 10 to about 50 seconds (to obtain total antimicrobial contact times of about 15 to about 60 seconds when combined with the exposure in step 1 above).

3. The test substrate cube was then placed in a Ziploc bag containing 100 mL of LST solution to neutralize any residual antimicrobial chemistry;

4. The Ziploc bag containing the test substrate cube was then vigorously shaken for about for 45 seconds to release bacterial cells from the surface of the meat into the LST solution;

5. A 100 μL aliquot of LST solution from the bag was injected into 9.9 mL of sterile phosphate buffer solution;

6. The LST solution was serially diluted, then plated on Salmonella Shigella agar and incubated for 24 h prior to counting presumptive positive Salmonella colonies;

7. This procedure was repeated at each concentration of DCDMH;

8. For controls, 2 cubes of each test substrate were treated as in steps 1-2 above, except the control substrate cubes were atomized with sterile deionized water in step 1 above. And then steps 2-6 of the process above were continued.

### Test Protocol—Dip Application

1. A test substrate cube was placed in a Ziploc bag containing 100 mL of the antimicrobial solution and allowed to remain in the solution for about 15 to about 30 seconds under gentle manual agitation;

2. The test substrate cube was removed from the test solution using sterile forceps and allowed to drip for about 0 to about 30 seconds (to obtain total antimicrobial contact times of about 15 to about 60 seconds when combined with the exposure in step 1 above);

3. The test substrate cube was then placed in a Ziploc bag containing 100 mL of LST solution to neutralize any residual antimicrobial chemistry;

4. The Ziploc bag containing the test substrate cube was then vigorously shaken for about for 45 seconds to release bacterial cells from the surface of the meat into the LST solution;

5. A 100 μL aliquot of LST solution from the bag was injected into 9.9 mL of sterile phosphate buffer solution;

6. The LST solution was serially diluted, then plated on Salmonella Shigella agar and incubated for 24 h prior to counting presumptive positive Salmonella colonies;

7. This procedure was repeated at each concentration of DCDMH;

8. For controls, 2 cubes of each test substrate were treated as in steps 1-2 above, except the control substrate cubes were placed in 100 mL Ziploc bags of phosphate buffer solution in step 1 above. And then steps 2-6 of the process above were continued.

TABLE 2
Results of the Antimicrobial Efficacy of 1,3,-dichloro-5,5,-
dimethylhydantoin (DCDMH) at Various Concentrations
Levels on Beef Test Substrates.

| | Active | | Time | Ave. Log | Ave. Log |
|---|---|---|---|---|---|
| Test Substrate | Cl (ppm) | Method | (seconds) | Reduction | Control |
| Beef Muscle | 100 | Dip | 60 | 0.89 | 5.38 |
| Beef Liver | 100 | Dip | 60 | 0.90 | 5.38 |
| Beef Muscle | 200 | Spray | 30 | 0.91 | 5.51 |
| Beef Liver | 200 | Spray | 30 | 1.01 | 5.51 |
| Beef Muscle | 400 | Dip | 15 | 1.18 | 5.48 |
| Beef Liver | 400 | Dip | 15 | 1.11 | 5.48 |

The foregoing working example, clearly demonstrates that DCDMH at concentrations from about 100 ppm to about 400 ppm, whether applied by dip application or spray application has great antimicrobial efficacy against S. Enteritidis. Under normal in-plant use conditions it is anticipated that efficacy in excess of a 1 log reduction would be easily achievable at these concentrations using these applications.

### Example 3—DCDMH Concentration Efficacy on Poultry

In the following working example, a study was conducted to compare the antimicrobial efficacy of 1,3,-dichloro-5,5,-dimethylhydantoin (DCDMH) at various concentrations (50 ppm, 100 ppm, and 200 ppm) on chicken test substrates, namely, chicken legs and chicken liver. Prior to exposure of the test substrates to the antimicrobial solutions having DCDMH, the test substrates were incubated for two hours in 1000 mL of broth of Salmonella Enterica serovar enteriditis (SE), which had been grown to a concentration of >6 log 10 in Nutrient Broth for 2 h at 35° C. Following exposure, the test substrates were removed from the Nutrient Broth and allowed to drain and air dry for about 30 minutes at ambient room temperature before testing began. The test was replicated 10 times for each concentration and two controls. The concentration of DCDMH was then tested on the exposed test substrates using spray and dip applications.

### Test Protocol—Spray Application

1. A test poultry product (e.g., chicken leg or chicken liver) was suspended on a stainless steel hook in a spray cabinet and sprayed until the part was drenched with antimicrobial solution, which was for about 5 to about 10 seconds;

2. The test poultry product was allowed to drip for about 10 to about 50 seconds (to obtain total antimicrobial contact times of about 15 to about 60 seconds when combined with the exposure in step 1 above);

3. The test poultry product was then placed in a Ziploc bag containing 200 mL of LST solution to neutralize any residual antimicrobial chemistry;

4. The Ziploc bag containing the test poultry product was then vigorously shaken for about for 45 seconds to release bacterial cells from the surface of the poultry product into the LST solution;

5. A 100 μL aliquot of LST solution from the bag was injected into 9.9 mL of sterile phosphate buffer solution;

6. The LST solution was serially diluted, then plated on Salmonella Shigella agar and incubated for 24-36 hours prior to counting presumptive positive Salmonella colonies;

7. This procedure was repeated at each concentration of DCDMH;

8. For controls, 2 poultry legs and 2 poultry livers for the corresponding test were treated as in steps 1-2 above, except the control poultry products were drenched with sterile deionized water in step 1 above. And then steps 2-6 of the process above were continued.

### Test Protocol—Dip Application

1. A test poultry product was placed in a Ziploc bag containing 200 mL of the antimicrobial solution and allowed to remain in the solution for about 15 to about 30 seconds under gentle manual agitation;

2. The test poultry product was removed from the test solution using sterile forceps and allowed to drip for about 0 to about 30 seconds (to obtain total antimicrobial contact times of about 15 to about 60 seconds when combined with the exposure in step 1 above);

3. The test poultry product was then placed in a Ziploc bag containing 200 mL broth of LST solution to neutralize any residual antimicrobial chemistry;

4. The Ziploc bag containing the test substrate cube was then vigorously shaken for about for 45 seconds to release bacterial cells from the surface of the meat into the LST solution;

5. A 100 μL aliquot of LST solution from the bag was injected into 9.9 mL of sterile phosphate buffer solution;

6. The LST solution was serially diluted, then plated on Salmonella Shigella agar and incubated for 24 h prior to counting presumptive positive Salmonella colonies;

7. This procedure was repeated at each concentration of DCDMH;

8. For controls, 2 poultry legs and 2 poultry liver for each test were treated as in steps 1-2 above, except the test substrate cubes were placed in 200 mL Ziploc bags of phosphate buffer solution in step 1 above. And then steps 2-6 of the process above were continued.

TABLE 3
Results of the Antimicrobial Efficacy of 1,3,-dichloro-5,5,-
dimethylhydantoin (DCDMH) at Various Concentrations
Levels on Poultry Products.

| | Active | | Time | Ave. Log | Ave. Log |
|---|---|---|---|---|---|
| Test Substrate | Cl (ppm) | Method | (seconds) | Reduction | Control |
| Chicken Leg | 50 | Dip | 60 | 0.78 | 5.45 |
| Chicken Liver | 50 | Dip | 60 | 0.69 | 5.45 |
| Chicken Leg | 100 | Spray | 30 | 0.86 | 5.72 |
| Chicken Liver | 100 | Spray | 30 | 0.72 | 5.72 |
| Chicken Leg | 200 | Dip | 15 | 1.22 | 5.49 |
| Chicken Liver | 200 | Dip | 15 | 1.07 | 5.49 |

The foregoing working example, clearly demonstrates that DCDMH at concentrations from about 50 ppm to about 200 ppm, whether applied by dip application or spray application has great antimicrobial efficacy against S. Enteritidis. Under normal in-plant use conditions it is anticipated that efficacy in excess of a 1 log reduction would be easily achievable at these concentrations using these applications.

Various aspects of systems, devices, and methods have been described herein. These aspects are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A method for the reduction in microbial activity in protein food products intended for human consumption, the method comprising:
contacting a protein food product with an intervention antimicrobial solution comprising about N,N′-dichloro-5,5-dialkylhydantoin, a N,N′-dichloro-5-ethyl-5-methylimidazolidine-2,4-dione, or combinations thereof.

2. The method of claim 1, wherein said intervention antimicrobial solution comprises 1,3,-dichloro-5,5,-dimethylhydantoin, 1,3-dichloro-5-ethyl-5-methylimidazolidine-2,4-dione, or combinations thereof.

3. The method of claim 1, wherein said protein food product is an animal contacted with said intervention antimicrobial solution while the animal is still alive.

4. The method of claim 1, wherein said protein food product is an animal contacted with said intervention antimicrobial solution after a chilling step.

5. The method of any claim 1, wherein said protein food product is a poultry carcass contacted with said intervention antimicrobial solution after the picking stage and prior to the chilling stage.

6. The method of claim 5, wherein said poultry carcass is contacted with said intervention antimicrobial solution during a soaking, dipping, quenching, rinsing or washing phase after a chilling stage.

7. The method of claim 1, wherein said protein food product is contacted with the solution prior to an evisceration step.

8. A method for the reduction in microbial activity of a poultry product intended for human consumption, the method comprising:
contacting a poultry product with an intervention antimicrobial solution comprising a N,N′-dichloro-5,5-dialkylhydantoin, a N,N′-dichloro-5-ethyl-5-methylimidazolidine-2,4-dione, or combinations thereof.

9. The method of claim 8, wherein said intervention antimicrobial solution comprises 1,3,-dichloro-5,5,-dimethylhydantoin, 1,3-dichloro-5-ethyl-5-methylimidazolidine-2,4-dione, or combinations thereof.

10. The method of claim 9, wherein said poultry product is contacted with said intervention antimicrobial solution while the animal is still alive.

11. The method of claim 9, wherein said poultry product is contacted with said intervention antimicrobial solution after a chilling step.

12. The method of any claim 9, wherein said poultry product is contacted with said intervention antimicrobial solution after the picking stage and prior to the chilling stage.

13. The method of claim 9, wherein said poultry product is contacted with said intervention antimicrobial solution during a soaking, dipping, quenching, rinsing or washing phase after a chilling stage.

14. The method of claim 9, wherein said poultry product is contacted with the solution prior to an evisceration step.

15. A method for the reduction in microbial activity of an animal food product intended for human consumption, the method comprising:
contacting a four-legged animal product with an intervention antimicrobial solution comprising a N,N′-dichloro-5,5-dialkylhydantoin, a N,N′-dichloro-5-ethyl-5-methylimidazolidine-2,4-dione, or combinations thereof.

16. The method of claim 15, wherein said antimicrobial intervention solution comprises 1,3,-dichloro-5,5,-dimethylhydantoin, 1,3-dichloro-5-ethyl-5-methylimidazolidine-2,4-dione, or combinations thereof.

17. The method of claim 16, wherein said four-legged animal product is contacted with said intervention antimicrobial solution while the animal is still alive.

18. The method of claim 16, wherein said four-legged animal product is contacted with said intervention antimicrobial solution after a chilling step.

19. The method of any claim 16, wherein said four-legged animal product is contacted with said intervention antimicrobial solution after a hide removal stage and prior to the chilling stage.

20. The method of claim 16, wherein said four-legged animal product is contacted with said intervention antimicrobial solution during a soaking, dipping, quenching, rinsing or washing phase after a chilling stage.

21. The method of claim 16, wherein said four-legged animal product is contacted with the solution during a hide or hair removal step.

22. The method of claim 16, wherein said four-legged animal product is contacted with the solution prior to an evisceration step.
